(19) United States
(12) Patent Application Publication
(10) Pub. No.: US 2012/0002101 A1
(43) Pub. Date: Jan. 5, 2012

(54) LIGHT IMAGING APPARATUS, SYSTEM AND METHOD

(75) Inventors: Serge Maitrejean, Paris (FR); Quentin Le Masne De Chermont, Paris (FR); Sebastien Bonzom, Vincennes (FR); Thomas Szlosek, Vincennes (FR)

(73) Assignee: BIOSPACE LAB, Paris (FR)

(21) Appl. No.: 12/995,227

(22) PCT Filed: May 29, 2009
(86) PCT No.: PCT/EP09/56653

§ 371 Date: May 27, 2011

(30) Foreign Application Priority Data
May 30, 2008 (EP) 08305218.3

(51) Int. Cl. H04N 5/225

(52) U.S. Cl. 348/373

(57) ABSTRACT

The imaging apparatus comprises a light-tight enclosure in which are enclosed: a detector adapted to detect a light signal emitted from a sample, a reflecting device comprising first and second reflecting portions reflecting toward first and second portions of the detector a signal emitted from first and second portions of the sample, the second reflecting portion reflecting toward a third portion of the detector a signal emitted from a the third portion of the sample and previously reflected by the first reflecting portion, a fourth portion of the detector directly detecting a signal emitted from a fourth portion of the sample.

### CROSS-REFERENCE

The present application is the United States National Stage of PCT/EP2009/056653, filed May 29, 2009, and claims priority to European patent application 08305218.3, filed May 30, 2008, the entirety of both of which is incorporated herein by reference.

### FIELD OF THE INVENTION

The instant invention relates to light imaging apparatus, systems and methods.

### BACKGROUND OF THE INVENTION

Imaging apparatus have been long known and used for their ability to obtain information related to an imaged sample. For volumetric samples, three-dimensional imaging has proven a very effective tool, since it provides three dimensional images, which mimic the three-dimensional shape of the sample itself. Because most sensing techniques involve bi-dimensional sensors, some three-dimensional imaging methods require a plurality of bi-dimensional images to be taken along different lines of sights, and calculation to be performed from these 2D images.

An example can, for example, be found in U.S. Pat. No. 7,113,217 where successive images are taken of luminescent light emitted from within a sample along different lines of sight. It is necessary to displace the sample with respect to the detector between two acquisitions. In other words, at a first step, luminescent light is detected from the top of the sample. Then the sample is moved in a position where one of its sides can be imaged, and another image is obtained at this position. These steps are repeated until a sufficient number of images have been taken from different lines of sight all around the sample.

However, the three-dimensional image obtained from these bi-dimensional images could be inaccurate, since the bi-dimensional images are taken one after the other. Inaccuracy could occur for example because the sample is moving between two images, because the signal to be detected is a transient signal which does not allow the time-consuming operation of displacing the sample between two acquisitions, because the operating state of the detector can not be maintained sufficiently constant for a time sufficient for acquiring all the images, or for many other reasons.

The instant invention has notably for object to mitigate those drawbacks.

### SUMMARY OF THE INVENTION

To this aim, it is provided an imaging apparatus comprising a light-tight enclosure in which are enclosed:
a support for receiving a sample to be imaged, the sample comprising distinct first, second, third and fourth portions,
a detector adapted to detect a light signal emitted from the sample, said detector comprising distinct first, second, third and fourth portions,
a reflecting device comprising:
   a first reflecting portion adapted to reflect toward the first portion of the detector a signal emitted from the first portion of the sample,
   a second reflecting portion adapted to reflect toward the second portion of the detector a signal emitted from the second portion of the sample,
the second reflecting portion being further adapted to reflect toward the third portion of the detector a signal emitted from the third portion of the sample and previously reflected by the first reflecting portion,
the fourth portion of the detector being adapted to detect a signal emitted from the fourth portion of the sample without reflection on the first nor second portions of the reflecting device.

With these features, simultaneous acquisitions from most of the sample can be obtained. These simultaneous images can be used for accurate 3D reconstruction, as detailed above, or for any other suitable purposes. Indeed, the simultaneous images can carry enough relevant information by themselves not to require an additional 3D reconstruction.

In some embodiments, one might also use one or more of the features as defined in the dependant apparatus and system claims.

According to another aspect, the invention relates to a light imaging method comprising
having a sample to be imaged to emit light signals from within its inside, said sample being received on a support of a light-tight enclosure, and comprising distinct first, second, third and fourth portions,
reflecting a light signal emitted from the first portion of the sample toward a first portion of a detector with a first reflecting portion,
reflecting a light signal emitted from the second portion of the sample toward a second portion of a detector with a second reflecting portion,
reflecting a light signal emitted from the third portion of the sample toward a third portion of a detector with both the first and the second reflecting portions,
detecting light signals from the first, second, third and fourth portions of the sample, with first, second, third and fourth distinct portions of a detector,

the fourth portion of the detector being adapted to detect a light signal emitted from the fourth portion of the sample without reflection on the first or second portions of the reflecting device.

In some embodiments, one might also use one or more of the features as defined in the dependent method claims.

### BRIEF DESCRIPTION OF THE DRAWINGS

Other characteristics and advantages of the invention appear from the following description of six embodiments thereof given by way of non-limiting example, and with reference to the accompanying drawings.

In the drawings:

FIG. 1 is a diagrammatic perspective view of an imaging apparatus;

FIG. 2 is a diagrammatic side view of the inside of the enclosure of the apparatus of FIG. 1 according to a first embodiment;

FIG. 3 is a block diagram of an example of processing the data;

FIG. 4 is a partial front view of the inside of the enclosure of the apparatus of FIG. 1 according to the first embodiment;

FIGS. 5a and 5b are schematic views obtained at the detector;

FIGS. 6a and 6b are views corresponding to FIGS. 5a and 5b respectively, after applying a suitable data treatment;

FIG. 7 is a schematic view of superimposed images;

FIG. 8 is a diagrammatic perspective view of a marking device; and

FIG. 9 is a schematic view of a method to obtain a 3D envelope,

FIG. 10 is a view similar to FIG. 4 according to a second embodiment,

FIG. 11 is a view similar to FIG. 4 for a third embodiment,

FIG. 12 is a view similar to FIG. 4 for a fourth embodiment,

FIG. 13 is a view similar to FIG. 2 for a fifth embodiment,

FIG. 14 is a partial 3D view for the fifth embodiment, and

FIG. 15 is a partial 3D view similar to FIG. 14 for a sixth embodiment.

### DETAILED DESCRIPTION OF THE INVENTION

In the various figures, like references designate elements that are identical or similar.

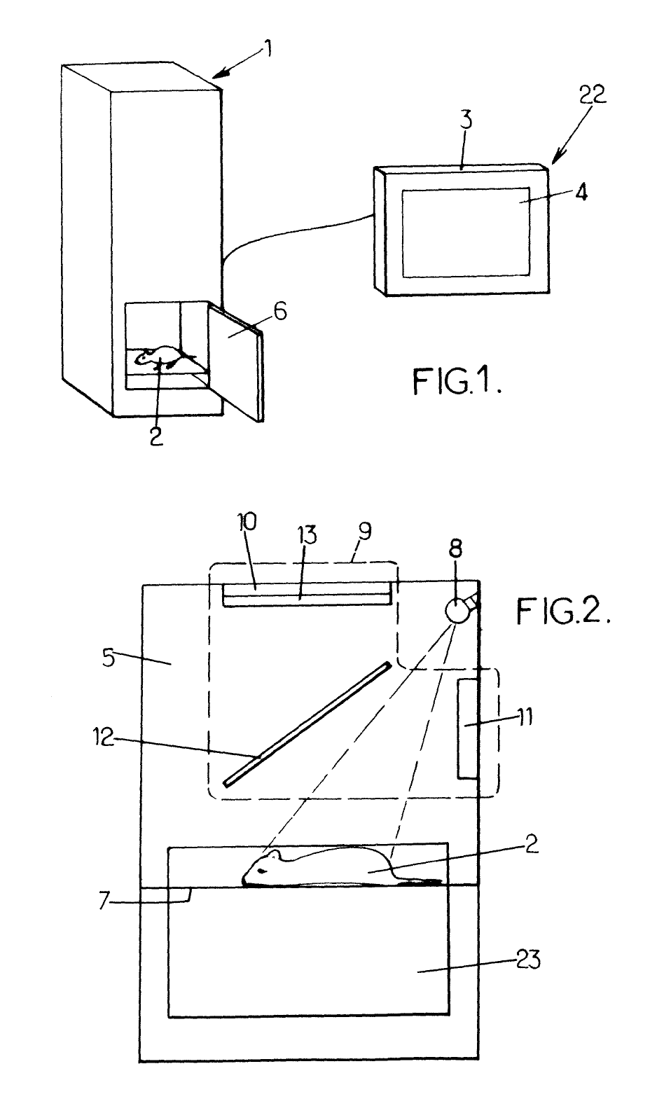

FIG. 1 diagrammatically shows an imaging apparatus 1 designed to take an image of a sample 2, and a computerized system 22 of conventional type comprising a central unit, viewing screen 3 comprising a display 4 showing an image of the sample 2. The apparatus 1 and computerized system 22 together are part of an imaging system.

The imaging apparatus described herein is a luminescence imaging apparatus, e.g. bioluminescence or fluorescence imaging apparatus, i.e. designed to take an image of a sample 2, such as, in particular, a small laboratory animal, e.g. a mammal, emitting light from inside its body. By light, it is understood an electro-magnetic radiation having a wavelength between 300 nm and 1300 nm, and preferably between 400 and 900 nm.

For example, said light is generated due to a chemical reaction inside the body of the small animal. In order to obtain the chemical reaction, it is possible, for example, to use a small laboratory animal that has been genetically modified to include a gene encoding for a protein that presents the particularity of emitting light, the gene being expressed under the control of a suitable promoter upon an event.

Before placing the laboratory animal 2 in the imaging apparatus 1, the event is generated. The quantity of light given off locally is representative of the quantity of produced protein, and thus makes it possible to locally measure the level of expression of the gene.

In particular, if it is desired to check whether the gene in question is expressed particularly in response to a given event, it is possible to implement the measurement explained above firstly for a small laboratory animal 2 for which the event has been triggered, and secondly for a small laboratory animal 2 for which the event has not been triggered, in order to compare the signals emitted by the two animals.

Alternatively, the experiment in question can, for example, consist in measuring the muscular activity generated by an event in a laboratory animal, by detecting the quantity of light emitted by the coelenterazine-aequorin substrate-photoprotein pair which reacts with a given complementary chemical entity. For example, the entity in question is calcium arriving in the proximity of the photoprotein at the axons.

Since such events have a very fast time signature, it is useful to obtain information relating to the reaction rate rapidly.

According to a possible embodiment, the present method is used when imaging a moving animal. A moving animal can be either awake and running in the imaging apparatus, or still (for example anesthetized). In this latter case, the animal's movement is mainly due to breath.

The apparatus described herein can also be used to implement a method of performing imaging by delayed luminescence or phosphorescence. During such a method, a molecule adapted to emit light by phosphorescence for a time that is sufficiently long, of the order of a few minutes, is illuminated ex-vivo in order to trigger said phosphorescence. The molecule is then introduced into a small laboratory animal and can be used as a light tracer. The concentration of the molecule in a location of the organism, e.g. because a certain reaction takes place at that location, and because the molecule in question participates in said reaction, is detectable by the apparatus described below and makes it possible to characterize the reaction in question quantitatively or qualitatively.

The apparatus and method described herein can also be used when light is emitted by fluorescence from inside the sample or the animal. Such emission can be obtained for example by exciting fluorescence probes contained inside the sample or the animal.

As shown in FIGS. 1 and 2, the small laboratory animal 2 is placed in an enclosure 5 that is made light-tight, e.g. by closing a door 6 or the like. By “light-tight”, it is understood that substantially no external light can enter the enclosure 5. As shown in FIG. 2, the enclosure has a stage 7 on which the small laboratory animal 2 is disposed, and a light source 8 generating incident illumination towards the stage 7 (e.g. conveyed by an optical fiber). The support 7 is performed translucent, for example made of a translucent solid material, or as a bundle or net of wires or the like.

Due to the above-described reaction, the small laboratory animal 2 naturally emits a luminescence signal that carries information relating to the luminescence of the small animal. In addition, due to the illumination generated by the light source 8, a positioning light signal, corresponding substantially to the incident illumination 8 being reflected by the small laboratory animal 2 is also emitted in the enclosure 5. The positioning light signal can also include a portion corresponding to the autofluorescence of the sample 2 due to the illumination by the light source 8.

The luminescent and positioning light signals combine to form a combined light signal arriving at the detecting device 9 shown outlined in dashed lines in FIG. 2.

With reference to FIG. 2, the detecting device comprises a first detector 10 suitable for detecting a light-emission image coming from inside the sample 2 and which present a luminescence spectrum. Such a first detector 10 is, for example, a cooled charge-coupled device (CCD) camera presenting a matrix of pixels disposed in rows and in columns, an intensified CCD (ICCD), an electron multiplying CCD (EMCCD, i.e. a CCD with internal multiplication) or the like. The detecting device 9 further comprises a second detector 11 which, for example, is a conventional or an intensified CCD camera, presenting a large number of pixels disposed in rows and in columns, suitable for detecting a positioning image of the sample. In the example shown in FIG. 2, each of the first and second detectors 10, 11 is disposed on a distinct face of the enclosure 5.

Further, the enclosure 5 contains a reflecting device 23 which will be described in more details below. The sample 2, the detectors 10, 11 and the reflecting device 23 are so placed that, if the detectors 10, 11 face the top of the sample 2, the reflecting device 23 faces the bottom of the sample 2. By “facing”, it is understood that two parts are considered “facing” if they are in optical relationship, even if this optical relationship is performed by way of intermediate light-reflecting or deviating devices.

In the example shown, the light source 8 emits incident illumination continuously towards the stage so that the combined light signal corresponds to a spectral combination of the luminescence light signal (carrying the luminescence information) and of the positioning light signal. The combined light signal is separated by a separator plate 12, which separates the signals on the basis of their wavelengths. For example, such a separator plate is a dichroic mirror or a mirror of the “hot mirror” type that separates visible from infrared. The luminescence light signal carrying the luminescence information is transmitted substantially in full towards the first detector 10, whereas the second light signal is transmitted substantially in full to the second detector 11.

In order to be sure that only the signal carrying the luminescence information reaches the first detector 10, it is also possible to dispose a filter 13 at the inlet of the first detector 10, which filter is adapted to prevent the wavelengths that do not correspond to that signal from reaching the first detector 10.

In practice, in order to be certain that the signal reaching the first detector 10 corresponds only to the luminescence from the inside of the sample 2, provision is made for the autofluorescence signal emitted by the sample 2 under the effect of the light source 8 to present a wavelength that is different from the wavelength of the signal in question. To this end, it is possible to choose to work with a light source 8 that emits incident illumination presenting an adapted spectrum, distributed beyond the range of wavelengths emitted by luminescence. For example, it is possible to use infrared illumination centered on a wavelength substantially equal to 800 nanometers (nm) when the luminescence spectrum presents a longest wavelength of 700 nm or shorter.

Other variations are possible, for example where the illumination is synchronized with the acquisition of the light-emission images by periodically shuttering the luminescent light-emission detecting camera, or where the detectors 10 and 11 are provided on the same wall of the enclosure, and the acquired data treated to be expressed in the same frame of reference, such as described in WO 2007/042641, which is hereby incorporated by reference in its entirely for all purposes, or using only the sensitive first detector 10 to acquire both the luminescence signal and the positioning signal one after the other, possibly in a repetitive fashion.

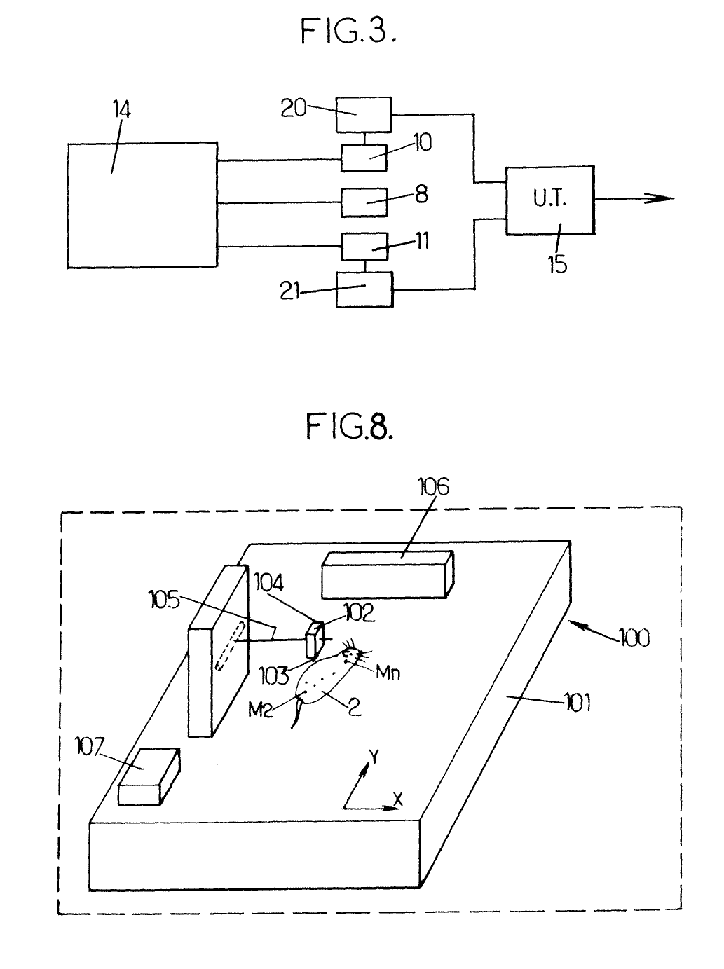

As shown in FIG. 3, an electronic control unit 14 is provided that defines a plurality of time frames of an observation period, each of which lasts a few milliseconds, corresponding substantially to the time necessary to acquire and to store a positioning image of the stage 7 by means of the second detector 11 from the positioning light signal. This positioning image comprises a plurality of data pairs comprising co-ordinates and a light property (brightness, etc.). It is possible to set said time frames to have a time determined by the user, if said user desires a given acquisition rate, e.g. such as 24 images per second, or some other rate. At the start of each time frame, the preceding signal generated in the second detector 11 is read and stored in a second memory 21, as are the co-ordinates relating to each pixel, and another acquisition starts at the second detector 11.

In similar manner, at the start of each time frame, the signal generated by the first detector 10 is stored in a first memory 20 as are the co-ordinates relating to each pixel. A processor unit 15 is adapted to read the data stored in the first and second memories 20, 21, so as store it and/or so as to display the corresponding images on the display 4. The components described on FIG. 3 are either part of the imaging apparatus 1 or of the associated computerized system 22.

However, it can happen that it is preferable not to read the data measured at the first detector 10 for each time frame, but rather once every n time frames, where n is greater than 1, in order to allow the light-emission signal to accumulate to improve the signal-to-noise ratio.

Of course, the imaging apparatus could also be used in a “static” non-live mode, where data is accumulated at the luminescence detector for a long time (minutes, hours, . . . ).

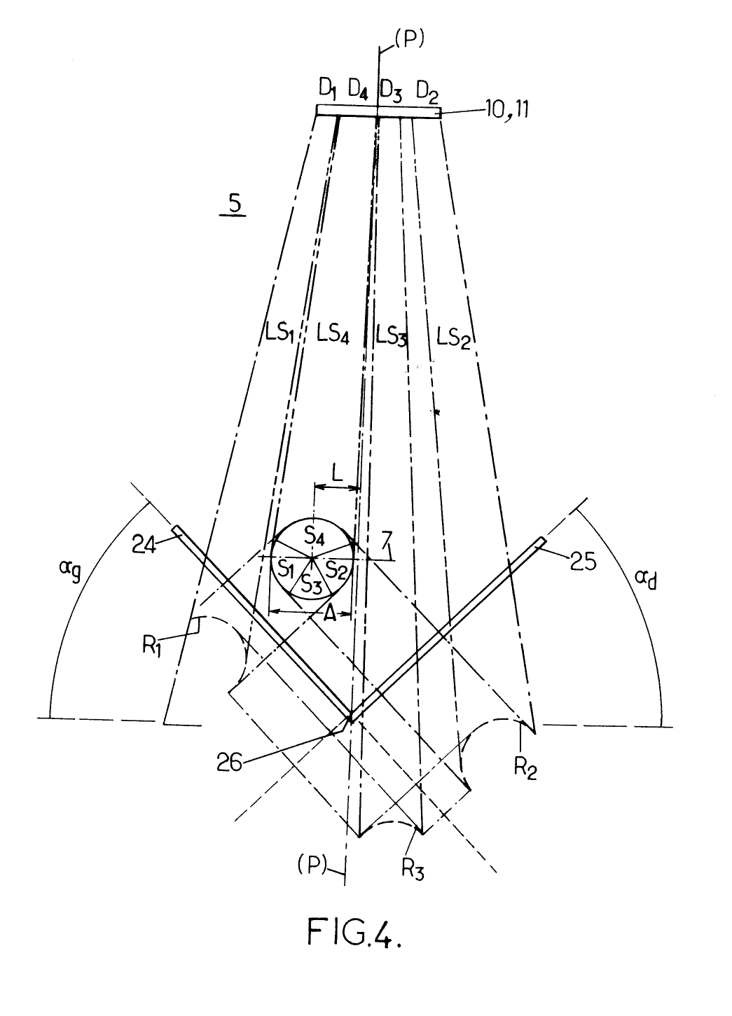

FIG. 4 now shows schematically a front view of the inside of the enclosure 5, according to a first embodiment. The sample 2 is schematically illustrated as a circle. The reflecting device 23 consists of a first reflecting portion 24 and a second reflecting portion 25 which are separated by a geometrical discontinuity 26. For example, the first and second reflecting portions are planar mirrors which are angled relative to one another at 26. For example, the planar mirrors 24 and 25 extend symmetrically with respect to a vertical plane P which extends transverse to the plane of the drawing. The plane P passes through the center line of the detector 10 and through the junction line of the mirrors 24 and 25. The sample support 7 (schematically shown in dotted lines) is designed to receive the sample 2 to be imaged in a sample receiving area A, the center of which is offset by a distance L from the plane P. The distance L may be for instance at least half of the width of the sample or animal to study. Typically, if the animal to study is a mouse, the width to be taken into account will be of about 3 cm and the distance L will be of about 1.5 cm. More generally, for animals or samples of this type of dimensions, the distance L may be of at least 5 mm.

The sample 2 can arbitrarily be divided in four separate portions: a first portion S₁ faces the first mirror 24; a second portion S₂ faces the second mirror 25; a fourth portion S₄ faces the detector 10; and a third portion S₃ is provided opposite the fourth portion S₄, between the first S₁ and second S₂ portions, facing both the first 24 and second 25 mirrors.

Similarly, the detector 10 can be divided in four portions which, from left right on FIG. 4 are named the first portion D1, the fourth portion D4, the third portion D3 and the second portion D2.

The detecting portions D1, D4, D3 and D2 are parts of a single planar detector.

A first light signal LS1 is emitted by the first portion S₁ of the sample 2 and reflected by the first mirror 24 to reach the first portion D1 at the detector, where it is detected. A second light signal LS2 is emitted by the second portion S₂ of the sample 2, is reflected by the second mirror 25 and reaches the second portion D2 of the detector where it is detected.

A third light signal LS3 is emitted by the third portion S3 of the sample 2, is reflected both by the first mirror 24 and the second mirror 25 and reaches the third portion D3 of the detector where it is detected. As it is apparent from FIG. 4, the third light signal LS3 is obtained partly by reflection of the light signal emitted from the third portion S₃ of the sample first on the first mirror 24 and then on the second mirror 25, and partly by the reflection of the third portion S₃ first on the second mirror 25 and then on the first mirror 24. However, this would depend on the initial position and size of the sample 2.

A fourth light signal LS4 emitted from the fourth portion S4 of the sample 2 reaches the fourth portion D4 of the detector without any reflection on the first mirror 24 nor the second mirror 25.

It is also apparent from FIG. 4 that some points of the sample 2 could be imaged by more than one portion of the detector 10. Yet, as illustrated, the four portions D1, D4, D3 and D2 of the detector 10 preferably do not overlap with one another.

Stated otherwise, the first portion D1 of the detector detects the reflection R1 of the sample 2 by the first mirror 24, the second portion D2 of the detector detects a reflection R2 of the sample 2 by the second mirror 25; the third portion D3 of the detector detects the reflection R3 of the sample 2 by both the first 24 and second 25 mirrors, whereas the fourth portion D4 of the detector 10 obtains a direct image of the sample 2.

As an example, the dimensions of the system are as follows. The floor of the enclosure is about 180 mm wide. The mirrors are placed above the floor, the junction point of the mirrors being 5 mm away from the floor. The mirrors each form an angle α_{g}, α_{d} of 45 degrees with the floor and have a length of 126.71 mm. The sample support is placed 83.06 mm above the floor, and the center of the sample receiving area is located about 25 mm from the central plane P of the imaging apparatus. The distance between the sample support and the detector is 445 mm.

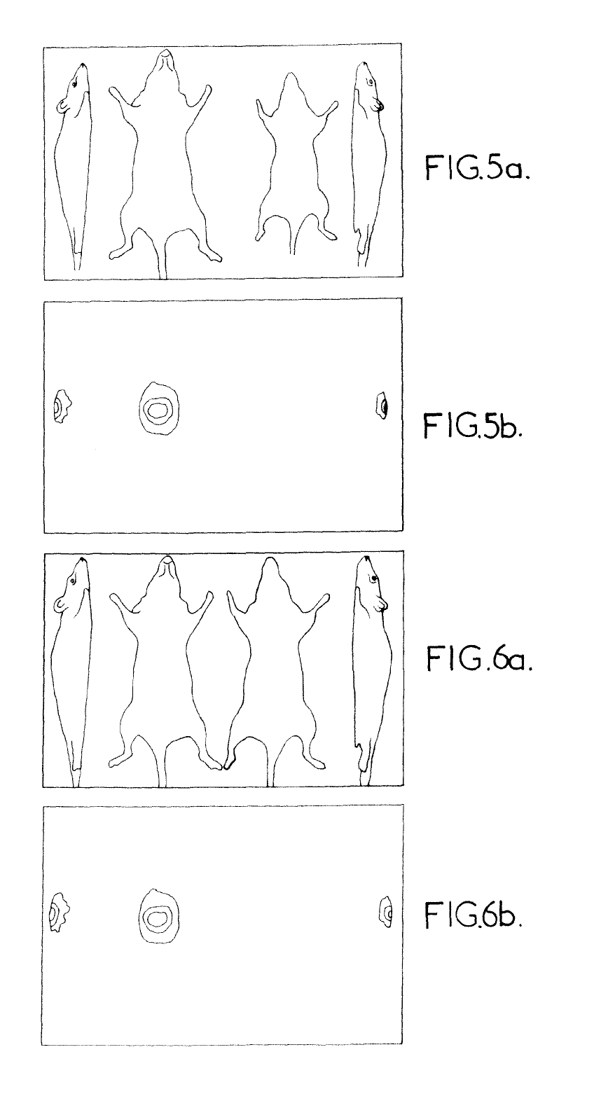

FIG. 4 shows the detection of the luminescence signal emitted from the sample 2 by the luminescent detector 10. An example of the detected data is schematically shown on FIG. 5b.

Although FIG. 4 is shown directly using the luminescence detector 10, it is understood that a similar geometry is obtained for the positioning detector 11 by way of the plate 12. Thus, the data detected by the positioning detector 11 is also shown on FIG. 5a.

According to an embodiment, it can be useful to apply a suitable processing to the detected data, in order to account for the fact that the optical distances between the detector and the various parts of the sample are different. For example, with the above described geometry, the images detected by portions D1 and D2 of the detector are of only about 90% of the size of the image detected by the fourth portion D4. Further, the image detected by the third portion D3 is about 80% of the size of the image detected by the fourth portion D4.

Thus, a suitable partial enlargement is performed to the images detected by both cameras, so that all four images are sized as if having been detected from a single virtual plane. This is shown on FIG. 6a for the positioning images and on FIG. 6b for the luminescent images. The displayed images are obtained by applying a different homothetic transformation to the data obtained from each portion of the detector. The homothetic transformation can, for example, displace the pixels by a given homothetic factor, while keeping the resolution.

The homothetic factors are obtained from an evaluation of the optical path of the light signal reaching the respective detector portions. These factors can be embedded into the computerized system, or calculated periodically from the known positions of the detector(s), the support 7 and of the reflecting device 24, 25, in particular if the support 7 is movable vertically inside the enclosure. A shown on FIG. 4, four different factors can be used for the four detector portions.

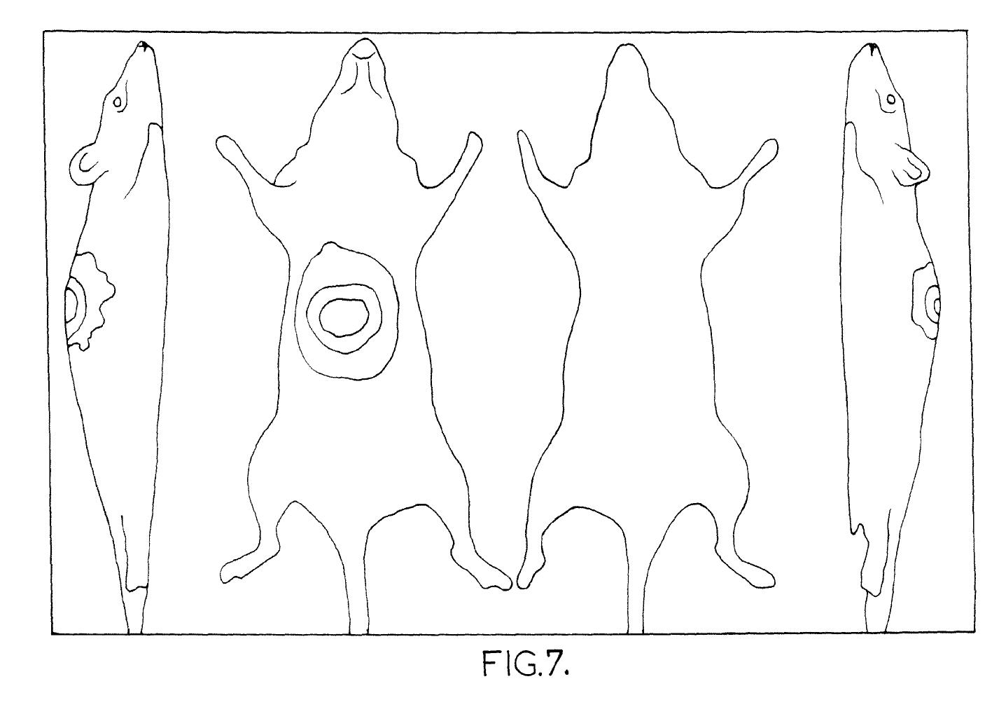

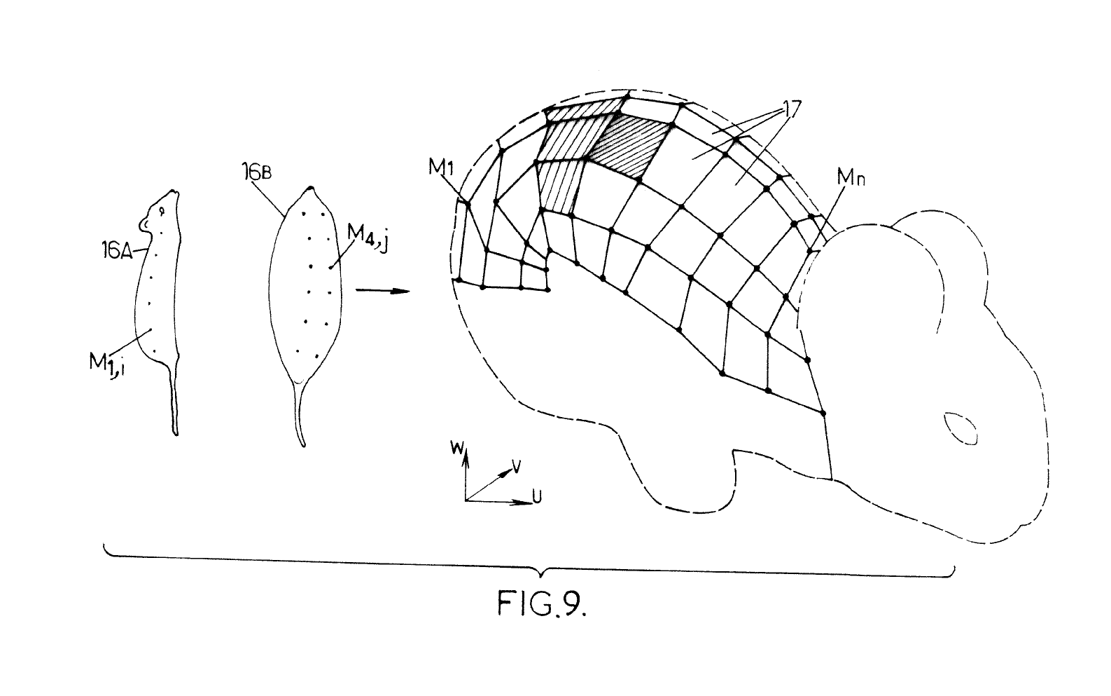

Further, as shown on FIG. 7, the corrected luminescent images can be superimposed to the corrected positioning images.

Of course, this superimposition could be performed directly on the data detected, such as shown on FIGS. 5a and 5b, and the enlargement of FIGS. 6a and 6b could be applied directly onto the superimposed images.

Next, an example of a method for obtaining three dimensional luminescent data, either surfacic or volumic, is described in relation to FIGS. 8 and 9. It should be noted that the below described method is only an example and that alternative methods could be applied within the scope of the invention.

FIG. 8 is an exemplary perspective view showing a marking device 100 suitable for marking an animal 2 with a suitable number of landmarks M₁, M₂, . . . , Mₙ, before placing it in the imaging apparatus.

The marking device 100 is for example an electronically controlled printing device comprising a support 101 adapted to receive the animal 2, for example previously anesthetized. A module 102 comprising a printing head 103 and an imaging camera 104 is carried at the end of an arm 105 movable with respect to the support 101 along two displacement axis X, Y in a plane parallel to the support above the animal 2. The printing head is in a fluid communication with an ink tank 106 providing ink to the printing head. A computerized control unit 107 controls the displacement of the arm 105 in the X-Y plane and the emission of an ink drop in suitable locations of the animal 2. Suitable locations are for example determined by an user having on a display screen the output of the imaging camera 104, and determining the locations of the ink drops.

Of course, the landmarks could be of any suitable shape, such as regularly spaced dots, lines, or any other suitable patterns. Further, the arm 105 could be made to move vertically out of the X-Y plane, for example keeping constant the printing head to animal distance.

Further, it should be noted that other embodiments of marking devices are possible.

The images from both positioning detector portions D1 and D4 are shown on the left of FIG. 9.

By a suitable data processing method, contours 16A, 16B can be extracted for each image from both detector portions. Further, the points M_{1,i} and M_{4,j} corresponding to the images by the first and fourth portions of the landmarks Mᵢ and Mⱼ, respectively, are extracted on the positioning images.

The three-dimensional position, in the frame of reference U, V, W of the enclosure for each of the points Mi of the animal's surface is calculated from the detected bi-dimensional position on both image portions obtained respectively from both detector portions. Knowing the geographical position of the positioning detector in the enclosure, the three-dimensional coordinates of the points can be stereoscopically determined from the offset, between the two image portions, of the points on the two image portions, such as applying one of the methods described in “Structure from stereo- a review”, Dhond and al., IEEE Transactions on Systems, Man and Cybernetics, Nov/Dec 1989, Volume 19, Issue 6, pp 1489-1510.

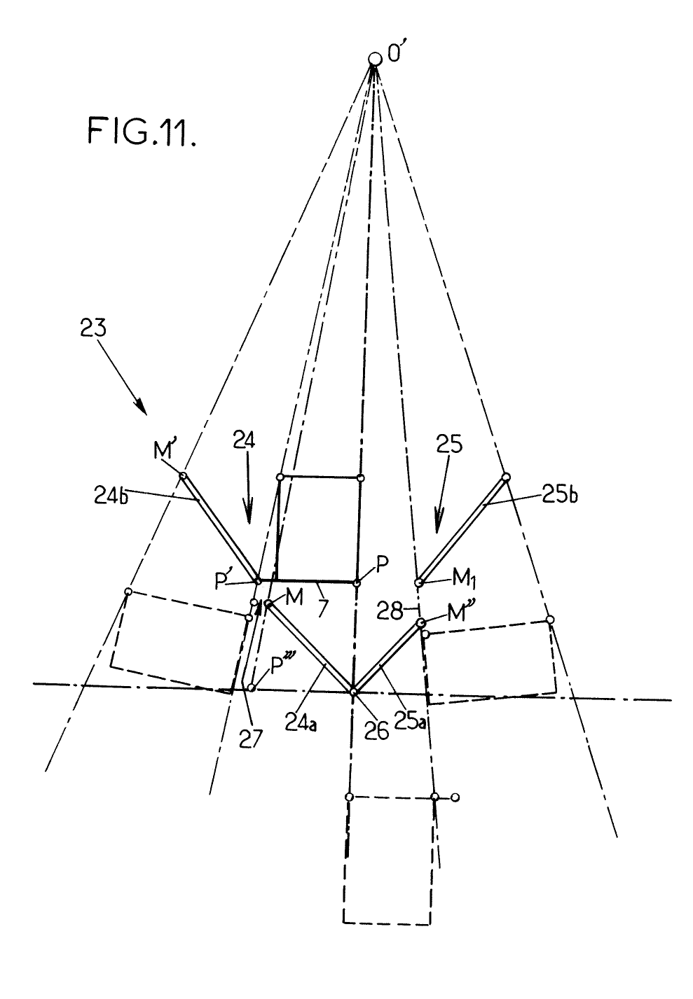

This calculation enables to roughly obtain the three-dimensional outer surface of the animal as shown on the right side of FIG. 11. Of course, FIG. 9 shows only the image portions obtained from portions D1 and D4 of the detector, but portions D3 and D2 can be used as well for determining the whole 3D envelope. The three-dimensional position of the point Mi of the surface of the animal is calculated from the two-dimensional positions of the points M_{1,i}and M_{4,i} on the respective image portions.

The light emission signal as detected by the luminescent detector 10 is projected onto the external surface as shown on the right side of FIG. 9. For each surface element 17, the density of light emission emitted from each surface element 17 is displayed by a suitable grey level or color on the display 4, and is represented on FIG. 9 by a more or less densely hatched element. For a pixel of the luminescence detector having an area AD, the area of the animal's outer surface corresponding to the pixel is A0, due to the outer surface inclination. Thus the measured output at this pixel is corrected to take into account this difference.

The resulting three-dimensional surfacic representation of the animal and three-dimensional surfacic light-emission image can be displayed superimposed as shown on FIG. 9.

If this is of interest, the 3D position of a light source inside the sample could be calculated from the 3D envelope and the detected luminescence data.

Knowing the distribution of light at each zone corresponding to the surface of the small laboratory animal 7, the computer can also be adapted to determine the locations of the light sources within the sample. During this step, it is desired to associate each internal zone of the volume of the small laboratory animal with a value for the luminescence emitted by said zone. For example, it is possible to implement a method whereby a plurality of virtual zones are defined inside the volume, and given knowledge of the distribution of soft tissue in the animal, e.g. obtained by earlier magnetic resonance imaging or computer tomography of the small laboratory animal, and consequently knowledge of the optical characteristics of each zone, it is possible by solving diffusion equations of light inside the sample, to determine the most likely disposition of the sources within the small animal that would lead to the surface distribution of light.

In a variant, the distribution of soft tissue is known from a generic model for the volume of a small laboratory animal, which model is deformed so as to be made to correspond with the locating data concerning the animal being subjected to detection, or by any other suitable method.

Although, in the present example, a two-stage calculation is implemented for determining the surface distribution of light at the surface of the sample from the acquired luminescence image, and then from said surface distribution the position and the intensity of light sources inside the sample, it would be entirely possible to implement a single calculation step during which the volume distribution of sources inside the sample is calculated directly from the luminescence signal detected by the detector without passing via the intermediate calculation of the surface distribution of light.

The above-mentioned detection and 3D surfacic or volumic calculations could be performed repeatedly for each time of an observation period, or for one time only.

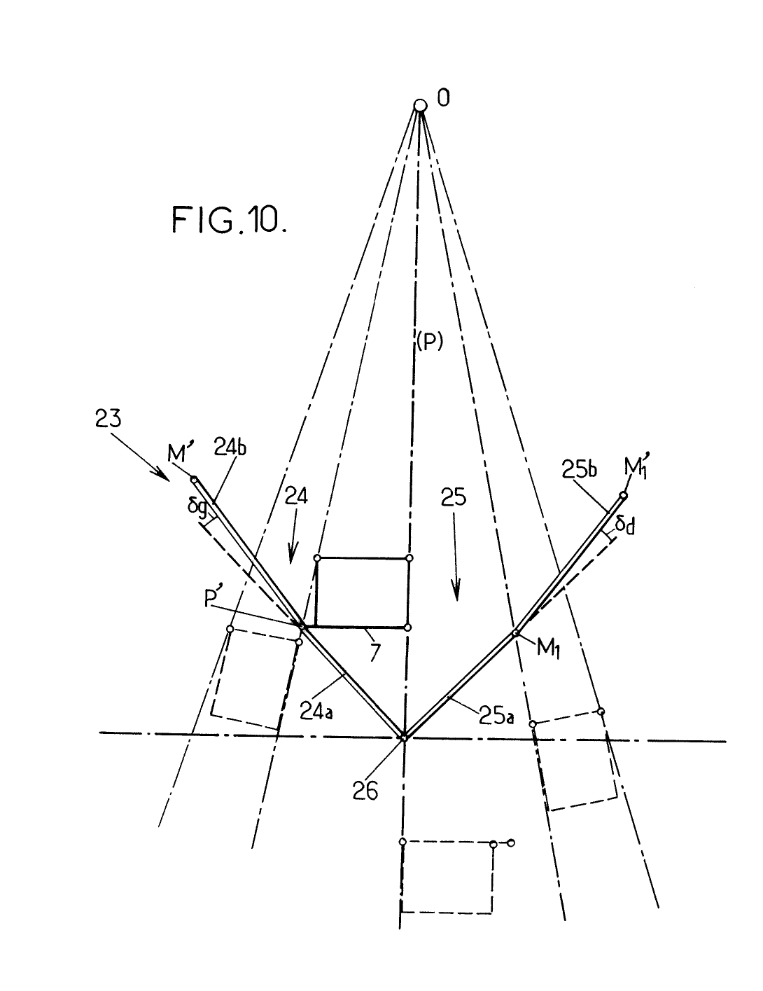

FIG. 10 now shows a variant embodiment of a reflecting device 23, which can be used to replace the embodiment shown on FIG. 4. The imaged sample is now schematically shown as a rectangular box instead of a circle. The detectors 10 and 11 are not shown on FIG. 10 but are situated approximately in the same location as on FIG. 4. As can be seen on FIG. 10, in the second embodiment, each of the first 24 and second 25 reflecting portions have a central portion 24a, 25a and an outer portion 24b, 25b.

For the first reflecting portion 24, which is the one closest to the sample, the first reflecting portion 24 extends continuously from the junction point 26 to an end point M′, with the outer portion 24b forming a non-zero angle with respect to the central portion 24a at point P′. Point P′ is for example level with the support 7 in a plane perpendicular to the plane (P). For example, the outer end of the support 7 is received in the first reflecting portion at point P′, as shown on FIG. 10. The angle between the outer portion 24b and the horizontal line is greater by a few degrees than the angle between the central portion 24a and that same horizontal line. This angle difference δ_{g} is for example between 1 degree and 10 degrees.

As can be seen on FIG. 4 for the first embodiment, the first portion D1 of the detector does not exactly take a lateral view of the sample, namely the bisecting line of the portion S1 of the sample is not orthogonal to the bisecting line of the portion S4 of the sample. Consequently, the view taken by the first portion D1 of the detector of the first embodiment is a little bit from beneath.

Forming a non-zero angle between the central 24a and outer 24b portions of the first portion 24 of the reflecting device enables to obtain, at the first portion of the detector, a view which is closer to a purely lateral view (of course depending on the size and position of the imaged sample).

As can be seen on FIG. 10, the second reflecting portion 25 exhibits a similar wedge in point M1 between the junction point 26 and the extremity M′1. The point M1 is, for example, located in the same plane as the support 7 and the point P′. The value of the angle difference δ_{d} with the horizontal, between the central portion 25a and the outer portion 25b, is also chosen sensibly between 1 degree and 10 degrees. For example, it can be equal to the angle difference for the first reflecting portion. However, since the sample is further away from the second reflecting portion 25 than from the first reflecting portion 24, the angle difference for the second reflecting portion 25 can be chosen smaller (for example 5%-50% smaller) than the angle difference for the first reflecting portion 24.

It will be appreciated that, depending on the imaging application, only the first or the second reflecting portion might be provided with such an angle discontinuity, the other of said reflecting portions being planar.

FIG. 11 now shows a third embodiment of the reflecting device 23 which is based on the second embodiment, which has been described above in relation to FIG. 10.

Compared to the second embodiment, the third embodiment is different in that the first reflecting portion 24 is made discontinuous, i.e., segmented, between the central 24a and the outer 24b portions. This gap 27 is provided so that a direct image of the support 7 through reflection by the central portion 24a of the first reflecting portion is not visible by the detectors 10, 11. Hence, for example, compared to FIG. 10, the segment P′M′ is the same (same length, same angular orientation), the point P′ still receiving the outer end of the support 7. The segment from the junction point 26 to the point P′ of FIG. 10 has the same orientation, but is shorter so that the point M, which is the outer end of the central portion 24a is on a line joining the focal point O′ to the point P″', which is the direct image of the central point P of the support 7 by the central portion 24a of the first reflecting device. It will be appreciated that the central portion 24a can be shifted upward or downward with respect to the embodiment of FIG. 10. The line joining the junction point 26 to the point M needs not intersect the line P′M′ at point P′.

Alternatively or in addition, the second reflecting portion 25 can also be segmented, as shown by the gap 28 on the right hand side of FIG. 11. The outer portion 25b has a similar orientation to that of FIG. 10, so that a lateral view of the sample can be obtained. The central portion 25a of the second reflecting portion 25 extends from the junction point 26 to an end point M″′ along the same orientation as in FIG. 10. However, the central portion 25a can be made shorter than in FIG. 10. In particular, point M″ can be selected so that there would not be any direct image of the support 7 through reflection by the central portion 25a of the second reflecting portion 25. This enables to shift the outer portion 25b of the second reflecting portion 25 leftward on FIG. 11, compared to the embodiment of FIG. 10, so that its central end M₁ is on the line joining the focal point O′ to the outer end M″ of the central portion 25a.

According to a variant embodiment of FIG. 11, which is not shown, the plane normal to the detector needs not necessarily be bisecting the angle between the central portions 24a and 25a. Stated otherwise, compared to the embodiment of FIG. 11, according to this variant, the central portions 24a and 25a are rotated by a few degrees (while the angle between both portions remains the same as that of FIG. 11, in particular equal to 90°). If necessary, the position of the rotated central portions 24a and 25a, taken together, can be adapted (by translation upward and/or sideways) relative to one or both outer mirrors 24b, 25b, for example to retain the construction of points M and M″ as explained above, for example to increase lateral space.

Obviously, for the embodiment of FIG. 11 or its not shown variant, it is possible, depending on the application, that only one of the reflecting portions 24 or 25 has the described geometry, the other being planar as on FIG. 4, or continuous but angled as on FIG. 10.

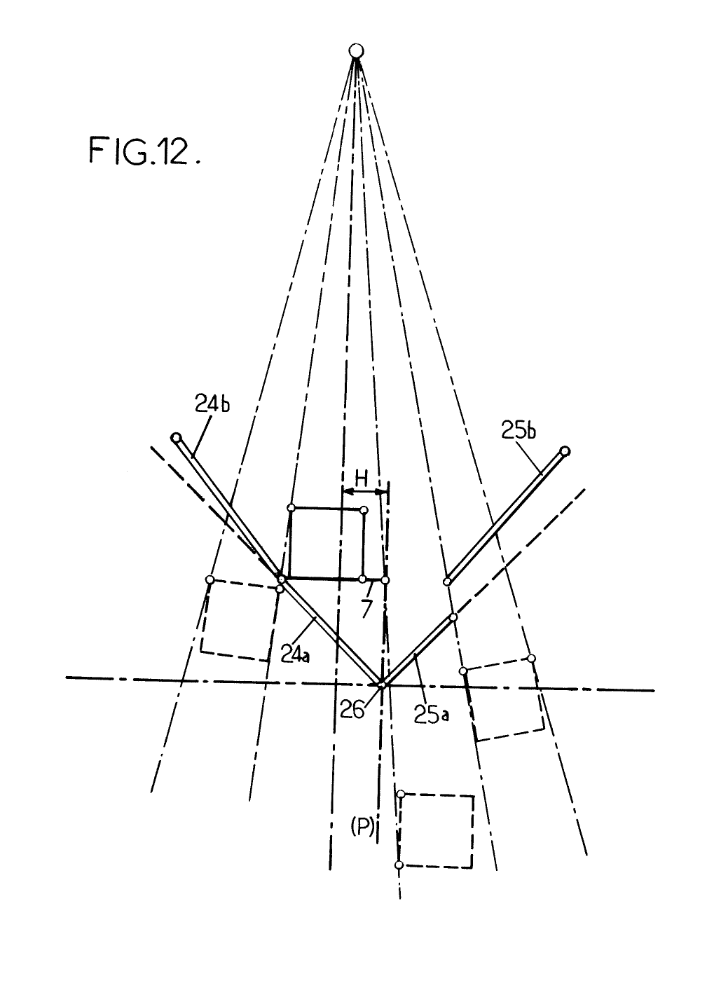

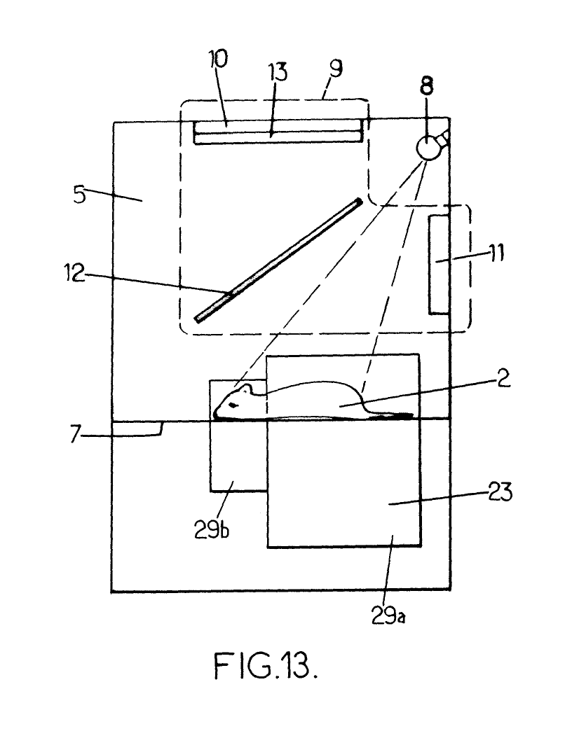

FIG. 12 now shows a fourth embodiment which is described below by reference to the first embodiment. In the embodiment of FIG. 12, the plane (P) still extends through the junction point 26 orthogonally to the detector plane, but the detector 10, 11 is offset by a distance H from the central plane (P). The value of the offset H might for example, but need not necessarily, be equal to the distance L between the plane (P) and the center of the support 7. Further, this embodiment is there exemplarily shown with the outer portion 24b, 25b of the reflecting portions 24, 25 angled with respect to their respective central portion 24a, 25a, as explained above for the second embodiment, although the planar geometry of FIG. 4 or the continuous geometry of FIG. 10 are possible here. With this configuration, the sample to be imaged can be brought in very close proximity to the first reflecting portion 24, thereby increasing the resolution at the detectors 10 and 11.

A benefit from this configuration is that the angular portion by which the first and second portions of the sample are viewed (lateral views) are equal in this configuration, which makes following signal handling easier (for example for the 3D reconstruction software).

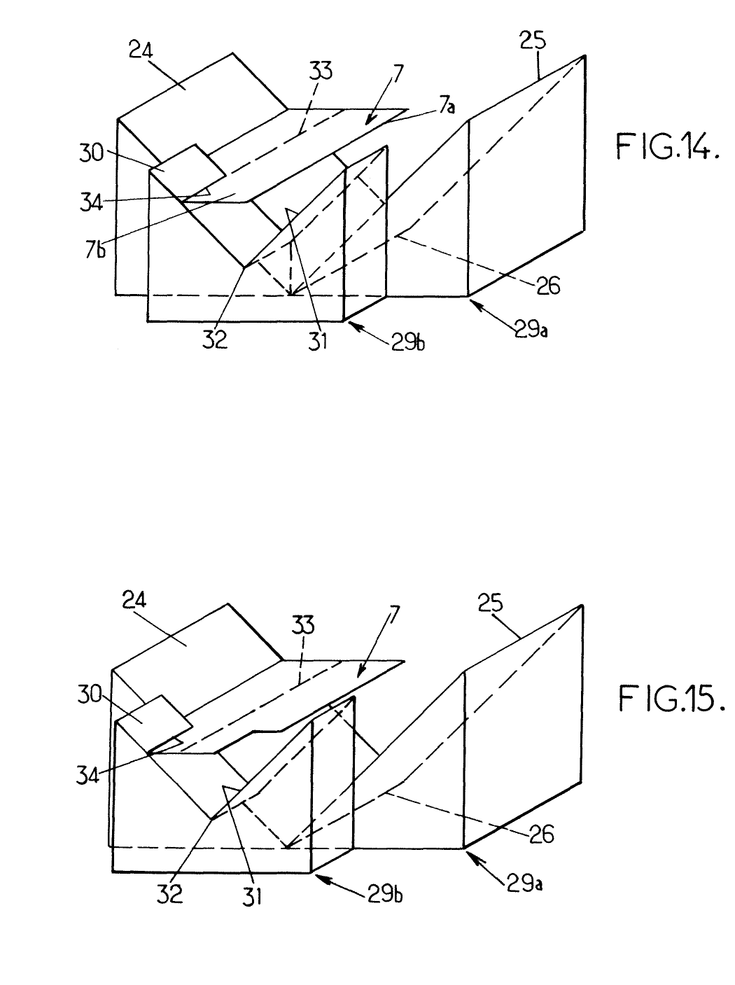

According to a fifth embodiment, as shown on FIG. 13, the reflecting device 23 is longitudinally separated in a plurality of portions such as, for example, as described, in two portions 29a and 29b. Portion 29a is level with the body of the laboratory animal, and has a cross section as shown above with respect to any of the previous embodiments (exemplarily shown on FIG. 14 with a cross-section as the one of FIG. 4). The section 29b is for example a head portion, located at the level of the head of the laboratory animal, or of a portion which is smaller than the body portion of the animal, and is a miniaturized reflecting device compared to the body reflecting device 29a. As it is visible in particular in FIG. 14, it has smaller reflecting mirrors 30, 31. The reflecting mirrors 30 and 31 themselves have a section according to any of the previously described embodiment, however on a smaller scale (exemplarily shown on FIG. 14 with a cross-section similar to the one of FIG. 4, on a lower scale). As shown, the reflecting mirrors 30 and 31 might have a similar profile as that of the reflecting mirrors 24 and 25, or a different profile, if appropriate.

In the fifth embodiment, the head portion 29b is shifted upwards, but not sideways, with respect to the body portion 29a. Hence, the junction line 26 and the junction line 32 between the mirrors 30 and 31 extend both in a plane normal to the detector plane. As shown on the embodiment of FIG. 4, this plane can pass, according to this embodiment, through the centre of the detector 10, 11 (not shown). The sample to be imaged is here shown as a dotted line 33 extending along the support 7, parallel to the junction lines 26 and 32, shifted sideways with respect to plan (P). The sample to be imaged will approximately be disposed along that line 33, with its body at the body portion 29a and the head at the head portion 29b. Hence, the line 33 is very close (shown equal) to a line 34 of intersection of the mirror 30 with the support 7. The support hence has a broad body portion 7a (sufficiently broad to receive the body of the sample) and a narrow portion 7b (sufficiently broad to partly receive the head of the sample, which is also partly received by the mirror 30).

As shown on FIG. 15, in the sixth embodiment, further to being moved upward with respect to the body portion, the head portion 29b of the reflecting device is moved sideways to the left. The detectors and the sample support 7 are not moved with respect to the embodiment of FIG. 14. In this way, the sample longitudinal line 33 is shifted sideways with respect to the line 34. A line 35, for example symmetrical to line 34 with respect to line 33, defines a cut-out in the support head portion 7b. Of course, other mirror geometries, as described above in relation to embodiments 1 to 4, are possible for this embodiment.

For the fifth and sixth embodiments, the magnification factor provided by the head portion 29b is different from that of the body portion 29a. If necessary, the computer system 22 is adapted to apply different geometrical corrections to data obtained from signals detected by different detector portions (in particular, ‘body’ portions of the detectors facing the body portion 29a of the reflecting device, and ‘head’ portions 10b, 11b, of the detectors facing the head portion 29b of the reflecting device), based on pre-defined calibration factors determined based on the geometric relationship between the head and body portions of the reflecting device.

Other geometries can be derived from the above geometries, for example in an attempt to bring the mirrors as close as possible to the imaged sample, while still imaging most (preferably all) of the sample circumference simultaneously.

1. An imaging apparatus, wherein the imaging apparatus comprises a light-tight enclosure in which are enclosed:
a support for receiving a sample to be imaged, the sample comprising distinct first, second, third and fourth portions,
a detector adapted to detect a light signal emitted from the sample, said detector comprising distinct first, second, third and fourth portions,
a reflecting device comprising:
a first reflecting portion adapted to reflect toward the first portion of the detector a signal emitted from the first portion of the sample,
a second reflecting portion adapted to reflect toward the second portion of the detector a signal emitted from the second portion of the sample,
the second reflecting portion being further adapted to reflect toward the third portion of the detector a signal emitted from the third portion of the sample and previously reflected by the first reflecting portion,
the fourth portion of the detector being adapted to detect a signal emitted from the fourth portion of the sample without reflection on the first nor second portions of the reflecting device.

2. The imaging apparatus according to claim 1 wherein the first, second, third and fourth portions of the detector are located in a detection plane.

3. The imaging apparatus according to claim 1 wherein the reflecting device comprises a geometrical discontinuity at which the first and second reflecting portions are separated, wherein the support has a sample-receiving area having a center, wherein the detector has a center, and wherein the center of the sample-receiving area is offset with respect to a plane going through said geometrical discontinuity and normal to the detector.

4. The imaging apparatus according to claim 3, wherein said plane goes through the center of the detector.

5. The imaging apparatus according to claim 3, wherein said plane is parallel to and offset with respect to a plane normal to the detector and going through the center of the detector.

6. The imaging apparatus according to claim 1, wherein the first and second reflecting portions are planar, and angled with respect to one another by an angle comprised between 60° and 120°.

7. The imagine apparatus according to claim 1, wherein at least one of said first and second reflecting portions comprises a central portion adapted to reflect a signal emitted by a third portion of the sample, and an outer portion adapted to reflect a signal emitted from the respective first and second portions of the sample.

8. The imaging apparatus according to claim 7 wherein the outer portion forms an angle chosen between 1 degree and 10 degrees with the central portion.

9. The imaging apparatus according to claim 7 wherein there is a gap between the outer portion and the central portion.

10. The imaging apparatus according claim 1 wherein the detector comprises a photo-multiplier adapted to intensify an incoming signal.

11. The imaging apparatus according to claim 1 wherein the support is translucent.

12. The imaging apparatus according to claim 1 further comprising:
an illumination device capable of taking an on-state in which it directs light toward the sample, and an off-state in which it does not direct light toward the sample,
a sequencer adapted to have the illumination device to take alternately its on-and it off-state,
wherein the sequencer is adapted to have the detector detect a luminescent light signal at least during the off-state.

13. An imaging system comprising an imaging apparatus according to claim 1 and a computerized system adapted to treat data corresponding to signals detected by the detector.

14. The imaging system according to claim 13, wherein the computerized system is adapted to apply at least one geometrical correction to data obtained from signals detected by at least one detector portion.

15. The imaging system according to claim 14, wherein the computerized system is adapted to apply different geometrical corrections to data obtained from signals detected by different detector portions, so as to obtain corrected data expressed in a single virtual detection plane.

16. A light imaging method, wherein the light imaging method comprises:
having a sample to be imaged to emit light signals from within its inside, said sample being received on a support of a light-tight enclosure, and comprising distinct first, second, third and fourth portions,
reflecting a light signal emitted from the first portion of the sample toward a first portion of a detector with a first reflecting portion,
reflecting a light signal emitted from the second portion of the sample toward a second portion of a detector with a second reflecting portion,
reflecting a light signal emitted from the third portion of the sample toward a third portion of a detector with both the first and the second reflecting portions,
detecting light signals from the first, second, third and fourth portions of the sample, with first, second, third and fourth distinct portions of a detector,
the fourth portion of the detector being adapted to detect a light signal emitted from the fourth portion of the sample without reflection on the first or second portions of the reflecting device.

17. The light imaging method according to claim 16, further comprising applying different geometrical corrections to data obtained from light signals detected by different detector portions, so as to obtain corrected data expressed in a single virtual detection plane.

18. The light imaging method according to claim 16, further comprising calculating a three-dimensional surfacic representation of light emission based on the detected light signals.

19. The light imaging method according to claim 16, further comprising calculating the three-dimensional position of a light-emission source inside the sample from the detected light signals.
